(19) United States
(12) Patent Application Publication
(10) Pub. No.: US 2020/0249337 A1
(43) Pub. Date: Aug. 6, 2020

(54) Radar based inverse detection sensor system

(71) Applicant: NOVELIC D.O.O., Belgrade (RS)

(72) Inventors: Tasovac Darko, Belgrade (RS); Rakic Dejan, Belgrade (RS); Veselin BRANKOVIC, Belgrade (RS); Veljko MIHAJLOVIC, Belgrade (RS)

(73) Assignee: NOVELIC D.O.O., Belgrade (RS)

(21) Appl. No.: 16/263,419

(22) Filed: Jan. 31, 2019

(51) Int. Cl. G01S 13/04; G01S 7/03

(52) U.S. Cl. CPC G01S 13/04; G01S 7/03

(57) ABSTRACT

The present invention discloses radar sensor system, operating in 24 GHz to 300 GHz frequency band, and its method of operation, comprising utilization of the passive markers, reflecting radio wave in the direction of illumination advantageously in cross polarization manner. The proposed system can detect if on the vehicle seat a baby, kid or adult average size person is sitting. The proposed system can detect intrusion, non-occupied area, belt speed, rotation speed and if the package is filled with sufficient level of liquids.

MM-wave radar sensor system described by apparatuses and method of operation is proposed addressing several applications. The proposed system is advantageously used for application regarding detection and classification of the human beings on the seats. Classes of the human being using seats detected by the proposed system are: adult, kid, being defined as human person smaller than average size of the human, and baby. The seat does not necessarily have the power supply. The same proposed system can be used for the classification of the objects having different heights and sizes, intrusion control, general space occupation, vehicle height detection and speed detection of latterly positioned objects and liquids.

### TECHNICAL FIELD

Radar sensor system with its method of operation using 24 GHz-300 GHz frequency band is introduced.

### BACKGROUND ART

The specific problems or classifying the people regarding its size is addressed by using mm-wave radar sensor frequencies. The proposed system is advantageously addressing classification of the human being occupying the vehicle seats and other applications.

There is a strong motivation to deploy a new generation of the sensor solution for the following automotive application scenarios, like in FIG. 1:

If the vehicle seat is occupied and acknowledged to:
a) Detect if the human with its average full size is on the seat
b) Detect if human with smaller size or kid is on the seat, where this size may be defined being larger that baby able to seat on the seat extension, to have a full function of the safety belt, and being smaller than human with its average size
c) Detect if the, baby in baby protection bed, is in the seat

Ideally the seat with the human, as a typical rear seat, does not have power supply, and does not have pressure sensor system.

The classification of the passenger in proposed classes as a state of art solution required complex pressure sensor systems, which required power supplies, so that the seats itself are generally more expensive.

There is a strong motivation to measure if the specific space is empty, or if the specific space is not empty: event intrusion, event passing through, event placing human or other object in the specific area, like in FIG. 2.

There is a strong motivation to measure and classify the size of the vehicles on road, like in FIG. 3. In these scenarios the height of the vehicles may be check to avoid road height limitations or traffic control is counting the number of the vehicles passing by having different classes of heights.

The alternative state of the art solution for applications in FIG. 2 and FIG. 3 is usage a laser sensor, which has a drawback to be influenced by dust, vapor other light sources, having hazardous influence to human eyes, it is more expensive compared to proposed system, and in some cases requests power supply on two sides, in contrast to proposed system having only one side power consumption.

There is a strong motivation to measure rotation speed or belt (angular) speeds in the industrial environments, like in FIG. 4. The alternative state of art solution is laser beam, which has a drawback to be influenced by dust, vapor other light sources and having hazardous influence to human eyes.

There is a strong motivation to measure and classify if the specific package is filled with liquids like in FIG. 5. The state of art solution with ToF (Time of flight) sensor, cannot differentiate if the package is full of liquid being placed on production belt, because the light is not passing through the package.

General state of the art radar sensors are used to detect distance, angle, vibration speed of the object. Typical product like automotive radars and industrial radar sensors are on the market. Proposed system concept differentiates substantially from classic radar sensors by measuring if the reflected radar signals are existing or not, and if they are existing, which class of received signal strength is detected.

The following set of the patent applications and granted patents as well as associated selected publications are describing the state of art in the field.

US20090058638, “Methods and apparatus for a pervasive locationing and presence detection systems”, disclosed a locationing system for use in a wireless network generally includes a wireless switch and a global positioning system (GPS) with RFID Network. At least one RFID reader (mobile and/or fixed) is configured to communicate with the access port, and the RFID reader is configured to read an RFID tag and communicate RFID tag data to the wireless switch. RFID reader is sending data and receiving ID from the RFID transponder, taking power from the emitter RF signal strength.

U.S. Pat. No. 9,325,077B2, “Radar level gauge system and reflector”, The present invention relates to reflector arrangement for proof test of a radar level gauge and to a radar level gauge system comprising such a reflector arrangement, for automotive tank application.

U.S. Pat. No. 8,350,75282, “Radar level gauge system with bottom . . . ” introduces a radar level gauge system, for determining a filling level of a product contained in a tank, the radar level gauge system comprising: a transceiver for generating, transmitting and receiving electromagnetic signals; a propagating device electrically connected to the transceiver and arranged to propagate a transmitted electromagnetic signal towards a surface of the product contained in the . . .

U.S. Pat. No. 5,387,916, “Automotive Navigation system and Method”, introduces the responder uses a Van Atta array antenna, using for navigation enhancement. The responder includes encoding means coupled to the receiving antenna means for imposing automotive navigation information on the collected interrogation signal, the responder including retrodirective means connected to the encoding means for retransmitting the encoding collected interrogation signal. This interrogator send coded signal by intention, addressing a vehicle travelling along a highway and it is not a part of the classing radar based distance collection systems.

US20150145711, “Retro-reflective radar patch antenna target for vehicle and road infrastructure identification” introduces a system concept where markers have preferably means of identifications, like RFID systems. The responders are emitting unique return signal so that the central controller identifying the roadway item of interest and determining a responsive action.

General background sources are explained the reflector planar approaches:

IEEE ANTENNAS AND WIRELESS PROPAGATION LETERS, VOL XX, 2018, “A Passive Re-Directing Van Atta Type Reflector”.

### SUMMARY OF INVENTION

This invention proposes a system having apparatus part 100 and apparatus part 2000, as well as the method of operation, being able to:
To detect the height of the passengers seating on the seat, within specific class of heights. This application scenario is shown in the FIG. 1.
To detect if in the observing specific area, there is an object being placed, where the object can be also a live being. This application scenario is shown in the FIG. 2.
To detect size of the objects. This application scenario is shown in the FIG. 3.
To detect the angular speed, like rotating object or lateral speeds like belt or flowing liquids. This application scenario is shown in the FIG. 4.
To detect if the package which should be filled by liquids, is filled properly with liquids, meaning that if the filling level is lower than determined to detect this event. This application scenario is shown in the FIG. 5.

The basic features of the apparatus 100 are described in the FIG. 6. Apparatus 100 is radar system having at least one transmitter and two receiver chains with high gain antennas, being connected to the vehicle infrastructure 1000, and being realised by the arbitrary technology solutions. The apparatus 2000 is passive system with the arbitrary realisation options, where passive means that the apparatus 2000 does not have power supply, where the apparatus 2000 has a feature that the incident radio waves to the apparatus receiving surface are reflected by approaching apparatus 2000 in the same angle as received. In the proposed invention apparatus 2000 can advantageously besides reflecting the way in the same direction also change the polarization of the incident ways. In the proposed invention at least one receive antenna of the apparatus 100 can have cross polarisation of at least one Tx antenna of the apparatus 100.

In the FIG. 7 different apparatus 2000 realization options are outlined, being realized by metalized corner reflectors, or printed planar structures, without and with changing of the incident radio waves polarisation.

By observing specific object by radar system, the total reflected energy to the radar systems is dependent on the level of the scattered waves in other directions as the direction of the incident waves. Due to the fact, that if the radar is receiving antennas and on the same place where transmit antennas are, the receiving power level from specific reflections is dependent of the level of scattering waves. If the object, would have features to reduce parasitic scattering and would reflect more power in the directions, where it is illuminated, its effective radar cross section would be larger, and receiving antenna at the radar will register more receiving power. With other words object having features for having less parasitic scattering and better reflection of the illuminated radio power to the direction of the illumination is better visible in the radar signal processing, compared to the environment in its enclosure without this feature. Even if the environment has metalized surfaces, the visibility is larger, if waves may be reflected in the same way where the Illumination of the signal is presented.

If the receiving antenna of the apparatus 100, is receiving cross polarized waves, regarding transmitted radio waves, and if the apparatus 2000 is reflecting waves in the direction of illumination with changing its polarization, the system can differentiate easily by observing receiving signal strength, if the apparatus 2000 is in position or existing at all or not. Due to the physical properties of the cross polarization antenna isolation 30 to 15 dB level differences can be expected. This invention is utilizing proposed innovative idea.

The key system-relevant components of the proposed apparatus 100 are:
High-gain planar antenna system, realized by the plurality of the technologies, with at least one receiving antenna system 110, 120, 130, 140 and at least one the transmit antenna systems 21 and 22 each of them having more than one antenna radiation elements, and operation in the mm-wave frequency band.
Advantageously one of at least one receiving antenna 110, 120, 130, 140, has cross polarisation to at least one Tx antenna 21 and 22.
Millimetre-wave radar with integrated front end on silicon 10, system on chip, providing analog processing of the mm-wave signal, and the provision of the analog to digital conversion functionality;
Digital signal processing functionality 30
Mechanical assembly with power supply interface to power supply infrastructure in the vehicle or front seats, containing mechanically integrated antenna, digital and analog functionalities and having mechanical connection to the vehicle or seat infrastructure
Supporting circuitry 50 as a part of apparatus 100 may include functionalities like light warning source, by the plurality of the realization options
Interface sub-system 60 allowing connection to the vehicle infrastructure 1000.

The choice to use the 24 GHz ISM Band and mm-wave frequency band (30 GHz to 300 GHz) and advantageously to use non-licenced 60 GHz band, ISM 60 GHz Band and 79 GHz Automotive band, is mainly related to the size of the antenna system allowing very small and compact device, even though it contains the high-gain antenna with more than one radiation elements. Usage of higher frequencies enables to have on predefined object more apparatuses 2000, where their radiation size is minimum 4×4 wavelengths under operation, for the practical realization purposes and for enhanced reflectiveness. Due to mm-wave frequencies in the practical applications advantageously more than one apparatus 2000 are utilized.

Following operation steps, being part of the proposed method of operation are executed:
In the application scenario, like described by FIG. 1, apparatus 100 is integrated in the vehicle infrastructure 1000. The apparatus 100 is illuminating specific seat 299 and detecting seat occupancy, by evaluating existing vital patterns, and at least two passive apparatuses 2000 are integrated in the seat. If the apparatus 100 is detecting the human being, the vehicle system is checking if at least one apparatus 2000 is detected. If no, the system concludes that the human body is blocking reflection of at least two apparatuses 2000, and the system is deciding the human in its full size is occupying the seat 299. If yes, the system is checking how may apparatuses are detected, by the plurality of the means: like the total receiving strength, which is larger than two apparatuses 2000 are illuminated than only one apparatus 2000 illuminated, due to the to the increased effective radar cross section, or by spatial recognition of the two reflection peaks by FMCW and beam forming antenna positions in two different areas of the seats. If only one apparatus 2000 is detected, the system concludes that human with small size, most probably kid, like in FIG. 1 c) is present on the seat. If two or more apparatus 2000 is detected, the system concludes that most probably baby in baby carriage is present on the seat. The vehicle environment 1000 is using event detection results: human average size detected, human with small size being probably kid, or baby in carriage is detected for other vehicle interaction and decision manners, like statistics evaluation, preparation of the specific monitoring functions, including vital signs observation or setting the exploding speed, and activation behaviour of the at lest one airbags. Advantageously the apparatus 2000 is reflecting the ways in the direction of illumination but changing polarization. In that case apparatus 100 has at least one receiving antenna with cross polarization mode of the transmit antenna and is receiving the signal being reflected from the apparatus 2000, in the case that radio way can propagate to apparatus 2000, meaning that between the apparatus 100 and apparatus 2000, there is no part of the human body or other object causing the strong reflection.
In the application scenarios, like described by FIG. 2, FIG. 3 and FIG. 4 apparatus 100 is illuminated radio waves, which are reflected by apparatus 2000, advantageously having cross polarisation. If the reflected radio waves by apparatus 2000 are approaching the apparatus 100 in sufficient strength level, which is related to the distance between apparatus 100 and known radar cross section of the apparatus 2000, we have one event, which is tracked in time. If the reflected radio waves by apparatus 2000 are not approaching the apparatus 100 in sufficient strength level, we have second event, which is also tracked in time. If the changes of the two events are regular, we may use the statistics of their appearance to detection of the more complex events, being related to different end applications.

### BRIEF DESCRIPTION OF DRAWINGS

FIG. 1 presents first class of proposed system application scenarios:

FIG. 1a) empty vehicle seats with integrated apparatuses 2000 in the vehicle seat

FIG. 1b) empty vehicle seats with integrated apparatuses 2000 in the vehicle seat, lateral view

FIG. 1c) vehicle seat being occupied by average human size, with no apparatuses 2000 being seen by the apparatus 100.

FIG. 1d) vehicle seat being occupied by kid or smaller human size, with one apparatus 2000 being seen by the apparatus 100.

FIG. 1e) vehicle seat being occupied by baby, with two apparatuses 2000 being seen by the apparatus 100.

where the apparatus 100 is radar system operating in 24-300 GHz range illuminating the vehicle seat having known specific placed along the vehicle height apparatuses 2000 being integrated in the vehicle seat.

FIG. 2 presents second class of proposed system application scenarios:

FIG. 2a) Lateral intrusion control scenario

FIG. 2b) Industrial vehicle good placing in the controlled not occupied area

FIG. 3 presents third class of proposed system application scenarios:

FIG. 3a) Hight controlling system, where smaller class of vehicle is passing

FIG. 3b) Hight controlling system, where larger class of vehicle is passing

FIG. 4 presents fourth class of proposed system application scenarios:

FIG. 4a) Detecting speed of the belt being marked with apparatuses 2000

FIG. 4b) Detecting rotation with rotated platform being marked with apparatuses 2000

FIG. 5 presents fifth class of proposed system application scenarios:

Detecting if the package on the moving belt is sufficiently filled with the liquid.

FIG. 6 presents functional blocks of the proposed Apparatus 100

FIG. 7 presents possible realisation options of the Apparatus 2000, where:

FIG. 7a) presents planar passive printed structure changing polarization of reflecting waves in the same direction of incident waves arrival

FIG. 7d) planar passive printed structure realized by patch type of antennas changing polarization of reflected waves in the same direction of incident waves arrival

### DESCRIPTION OF EMBODIMENTS

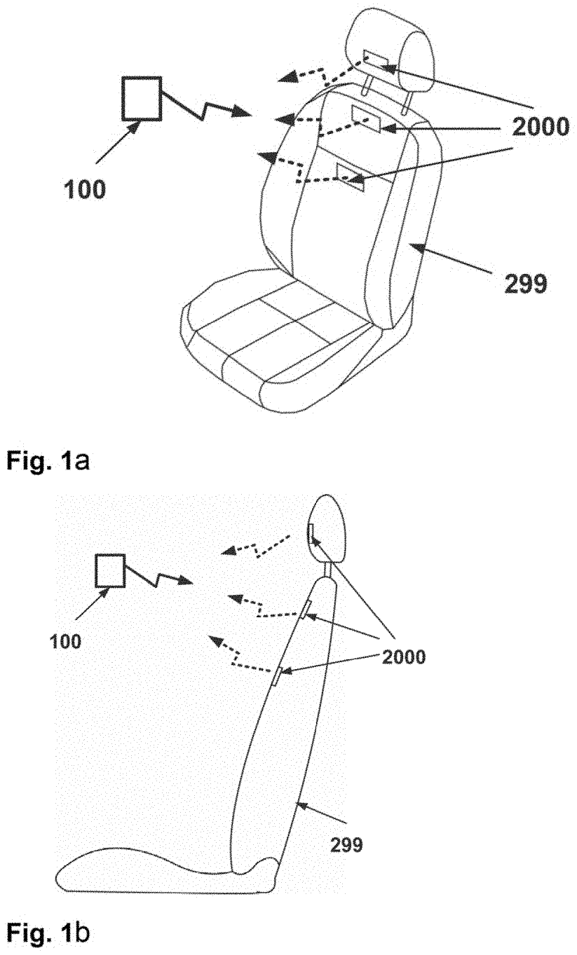

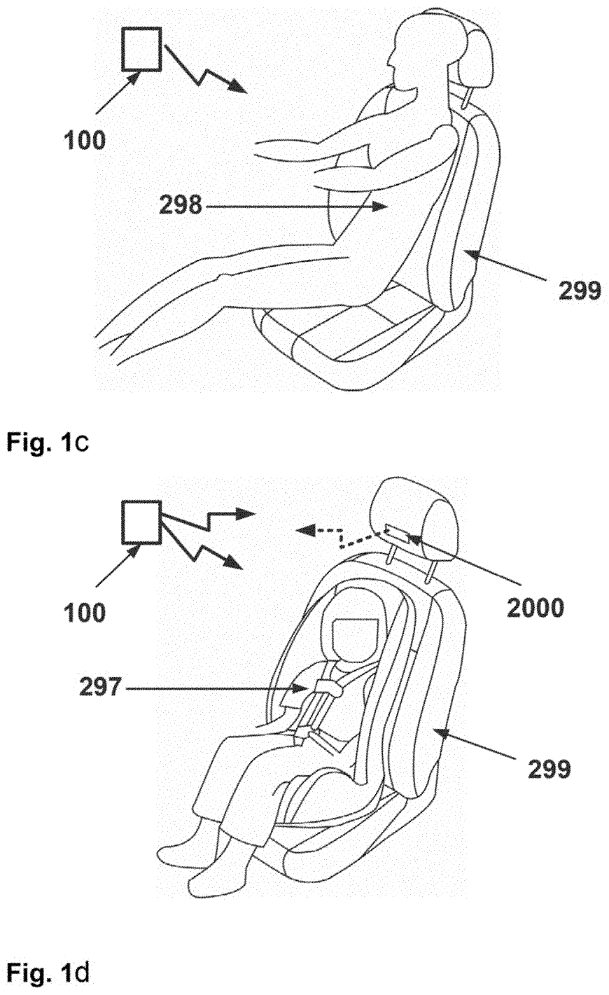

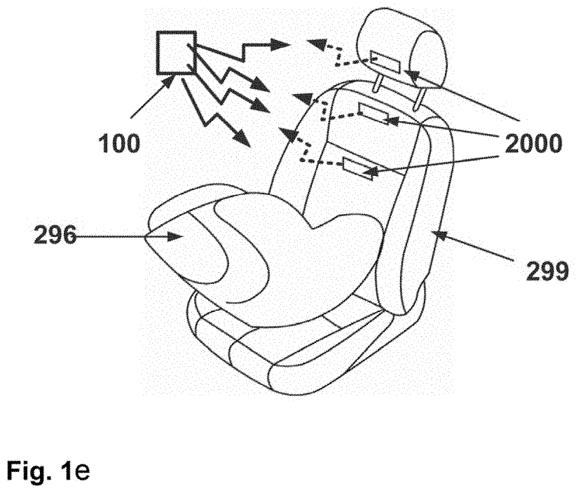

Radar based system, using frequency range of 24 GHz and 30-300 GHz comprising the one apparatus 100 with HW radar functionality, and at least two apparatuses 2000 being placed physically at the distance from apparatus 100, being integrated in the vehicle seat 299, like in FIG. 1. Apparatus 100 contains:
At least one high-gain planar antenna for transmitting mm-wave radio signals 21, where the high-gain planar antenna has at least two radiation elements;
At least one high-gain planar antenna for receiving mm-wave radio signals 110, where the high-gain planar antenna has at least two radiation elements; and has cross polarization, compared to antenna 21;
Integrated radio front end 10, implemented in arbitrary semiconductor technology, having on-chip integrated mm-wave voltage control oscillator, mm-wave power amplifier, at least one mm-wave IQ demodulator, digital control interface, power supply;
Digital processing functionality 30 with arbitrary hard wired and SW digital processing capability, being able to digitally process the signal coming out of the entity 10, including controlling functionality and calculation and memory capacity for performing digital signal processing by arbitrary type of the realization options
Wired communication interface 60 to connect first Apparatus 100 to the vehicle infrastructure entity 1000, being outside the apparatus 100, being released by the plurality of the technologies and communication protocols
Supporting circuitry 50, including mechanical interface to vehicle infrastructure environment 1000, where the first Apparatus 100 is connected to the infrastructure environment, and supporting electronic circuitry for provide the power supply from the vehicle environment 1000 to the first apparatus 100.

where the second apparatuses 2000 are a passive, without power supply, and without capability of charging by the Illumination of the radio waves being released by plurality of realization options, having a key feature to reflect the incident radio waves coming from apparatus 100 by changing its polariton to be cross polarized, in the same direction, where radio waves are approaching the apparatus 2000.

At least two apparatuses 2000, are integrated in the vehicle seat 299. The Method of operation related to the FIG. 1 where method of operation comprising three operation steps: “detecting seat occupancy” being declared as a first operation step, “detection of apparatuses 2000, by apparatus 100” being declared as second operation step, to be executed after the first step is executed, and “method for calculating human being classification”, being declared as third operation step to be executed after the second step is executed,

where the first operation step has following sub-set of operations:
Detecting by apparatus 100, if the human being is on the seat by using plurality of the approaches

where the second operation step has following sub-set of operations:
Transmission of radio waves signals generated in 10 using 21;
Receiving radio waves signals reflected by apparatus 2000 area using at least one receiving antenna 110;
Signal processing and detection at least three classes of the information:
   Class one: no signal level detected above specific pre-defined threshold one
   Class two: signal level detected above specific pre-defined threshold one, and lower than pre-defined threshold two, where the predefined threshold two is larger than predefined threshold one
   Class three: signal level detected above specific pre-defined threshold three, where the predefined threshold two is larger than predefined threshold two

where third operation step being executed after the second operation step, has following sub-set of operations:
Mapping detected class of signal level to the event detection of the human being classification, according to the following rules:
   If Class one is detected: average size human being is on the seat, like in FIG. 1c)
   If Class two is detected: smaller human being size, most probably a kid is on the seat, like in FIG. 1d)
   If Class three is detected: smaller life being is on the seat, most probably baby, like in FIG. 1e)
Detected event is communicated to the vehicle environment 1000, by means of entity 60.

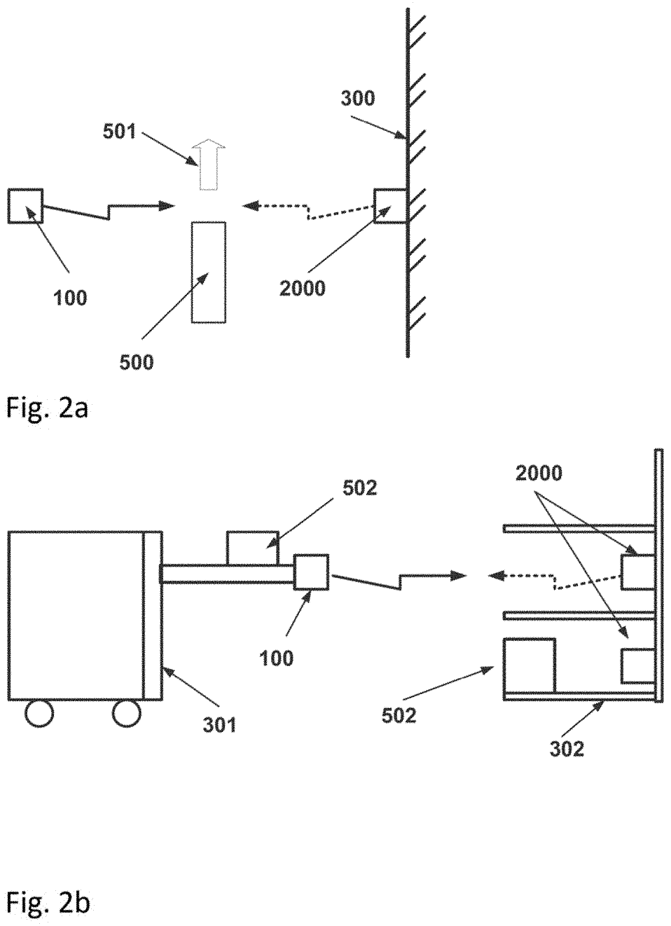

In FIG. 2 further proposed application scenarios are proposed. FIG. 2a) shows a case where apparatus 100 is connected to the fixed non-moving infrastructure with provided power supply. Apparatus 100 is facing apparatus 2000 connected to the wall or other fixed non-moving infrastructure 300. The distance between apparatus 100 and apparatus 2000 is known and does not change in the scope of the system operation. Apparatus 100 is constantly receiving reflected signals from the apparatus 2000. In the case when moving object, human, or life being defined as intruder 500 is passing in direction perpendicular or with direction having trajectory component 501, being perpendicular to radio connection between apparatus 100 and apparatus 2000 connection, the reflected signal coming from apparatus 2000, cannot be registered by the apparatus 100. In that case the system declares the event as intrusion and initialise related actions, such as communication the event with a specific time stamp to the world outside of the apparatus 100. Since the reflected waves from the apparatus 2000 are cross polarized, and intruder is reflecting radio ways in the same polarization, the falls alarms are small. The same principle can be used for people counting passing corridor, or to object counting passing controlled area. FIG. 2b) shows a case where apparatus 100 is connected to the moving platform 301 with provided power supply. This platform can be transportation vehicle, building machinery vehicle or production and logistic related small industrial vehicle. Apparatus 100 is connected on the moving part of the vehicle 301, transporting load 502. Load 502 is intended to be stored in the fixed infrastructure area 302 used for storage. Vehicle 301 is trying to off-load the load 502 in the free area. Coming close to the storage area the apparatus 100 is activated and the apparatus 100 is checking if the received signal from apparatus 200 being integrated at the end part of the storage area can be detected. If yes, the system decides that the area is free and load 502 can be off-loaded, if not like lower part of the storage area 302, the apparatus 100 cannot detect reflected waves from apparatus 2000, because apparatus 2000 is blocked by the load already been there. Today state of the art logistic systems with autonomous platforms, are offloading goods related to the data base, without checking if the related area is occupied or not. They are presuming that no one has access to the logistic area or that the date base has not mistakes and that the data base is up to date. In the proposed application scenario thy system can additionally improved the total safety and contribute to the full optimisation of the logistic process.

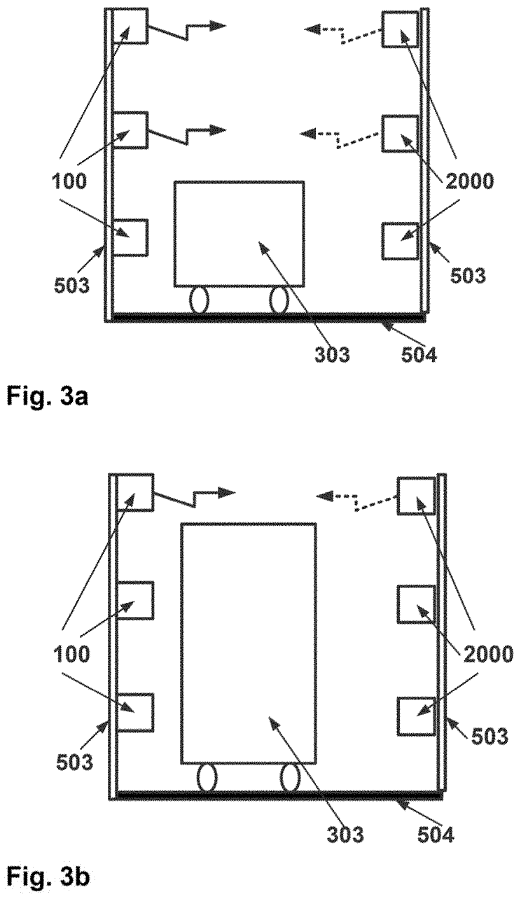

FIG. 3 shows application scenario related to the traffic infrastructure. Vehicles 303 are driving over the roads 504. We are prosing installation of the fixed infrastructure 503 across roads 504. On the Infrastructure 504 each pars of the apparatuses 100 and apparatuses 2000 on the same height are installed. At least one system in upper part of the structure is installed. In FIG. 3 b) Apparatus 100 is checking permanently the reflected signal from the associated apparatus 2000. If the signal is broken, the event that the vehicle excided the prescribed height is detected, and the apparatus 100 is sending an alert with the time stamp over entity 60 to the traffic infrastructure information system, which initialize related actions. FIG. 34) addresses applications where more sets of the sensors are used simultaneously, which allows to make categorization of the vehicles in the height classes, and their counting.

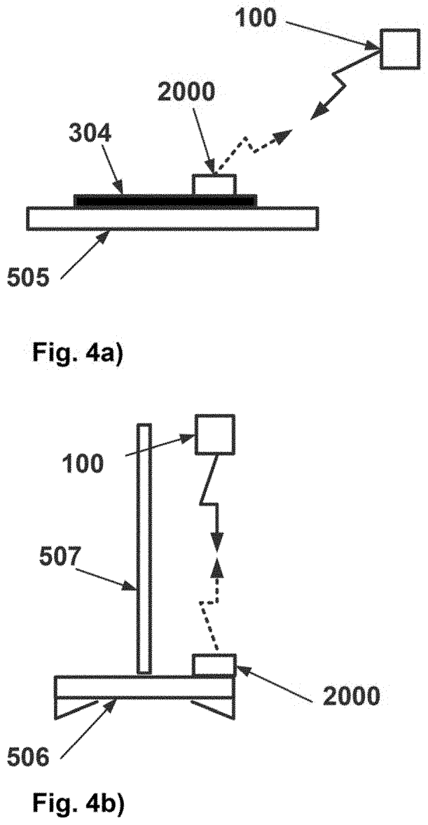

FIG. 4 shows application scenario related to system being capable to measure lateral and rotation speed. In the FIG. 4a industrial infrastructure 505 is having rolling belt 304, having more than two integrated apparatuses 2000, advantageously at the same distance. Apparatus 100 has a fixed position in the industrial environment and it is measuring if the reflected waves from apparatuses 2000 can be detected. Having information about two successive appearances of the apparatuses 2000 and knowing their distances on the belt 304, the lateral speed of the belt is calculated. This proposed principle can be applied for all moving object being marked by the apparatuses 2000, passing close to the controlling point with the installed apparatus 100. FIG. 4b) shows rotation platform 506, having rotation axes 507. Rotation platform 506 has at least one apparatus 2000 being integrated in 506. Apparatus 100 is measuring the time between two appearances from reflected signals coming from apparatuses 2000, and knowing their radial position, rotation speed can be calculated.

This system can be used for angular encoders.

This system can be used as a sensor for measuring liquids flow, where the rotation road 507 is fixed, and the moving platform has wings, influencing the rotation of the platform proportional to the speed of the moving liquids. The special case of water flow measurements is acknowledged.

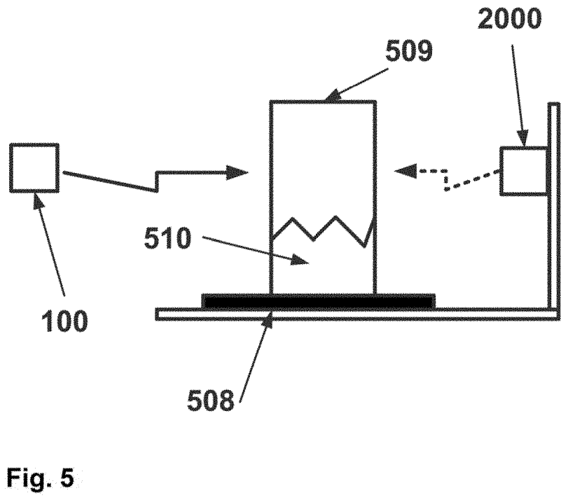

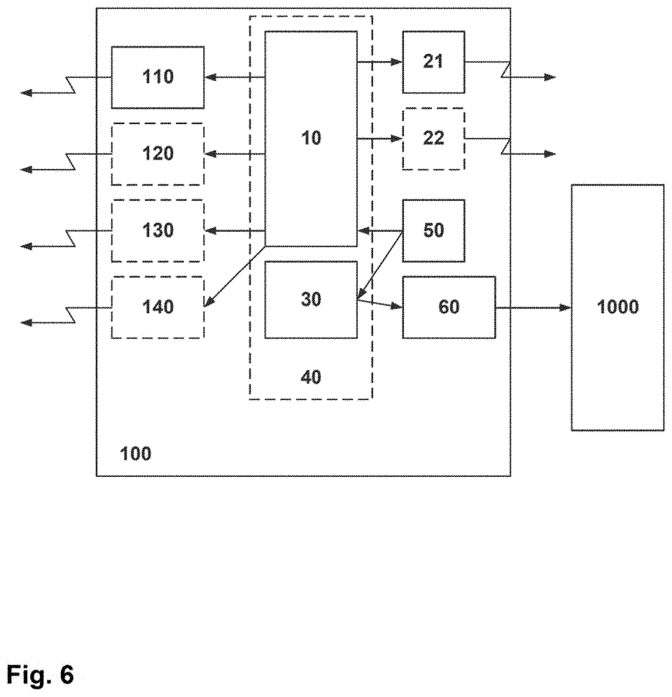

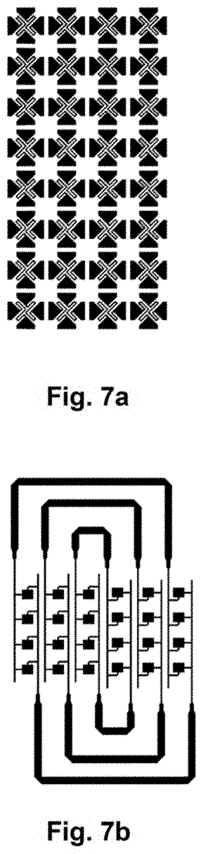

FIG. 5 shows application scenario typical for food industry, where juices, water, wine, milk and other liquids are packed. There is a problem that due to the damages in the production line, the package, which should contain liquid, is not full according to the pre-defined liquid level. So special sensor is requested, to detected packages which are not filled properly. The proposed system for this application scenario consists of apparatus 100 and apparatus 2000 being on the same height and the specific predefined distances. Between them the rolling belt 508 with packages 509 are passing buy, each having liquid level 510. Apparatus 100 is observing reflected signals from apparatus 2000, and due to the known speed of the belt 508, the apparatus 100 is not receiving the reflected signals from apparatus 2000 when the package full of liquid is filled in the proper and prescribed ways. If apparatus 100 is receiving signals when non-receiving time is to be detected, that means reflected ways are passing though package because the liquid level is too small. Therefore, the information with the time stamp is sent by the entity 60 outside apparatus 100, to initialize specific actions, like omitting as quality measured delivering the package to the customers without prescribed level of the filled liquids.

Furthermore, to described applications, where proposed system, being defined through its apparatuses and method of operation, is used, the calculated information and events may be used for the statistical evaluation of the data.

This includes:
Statistic evaluation what classes of the passengers and with which percentage are using dedicated seats, providing profiling of the seat occupancy
Statistic evaluation of how many intruders passes control points, in specific merits of time.
Statistic evaluation of the lateral or rotation speed profiles of the object under observation
Statistic evaluation of the vehicle classes passing through roads
Statistic evaluation of the large vehicle with the probability to endanger safety on the roads
Statistic evaluation of the packages do not comply the quality standards of liquid filling level

By using artificial intelligence algorfthmics, with machine learning in the place, the proposed system, being defined by its apparatuses and methods of operations, can be advantageously used for Improving decision quality in the corner cases, close to toady hard and empiric hard pre-defined sets of decision thresholds, which may be exchanged with soft type of the thresholds.

1: The System operating in 24 GHz to 300 GHz frequency band comprising one apparatus 100 with HW radar functionality, and at least two apparatuses 2000 being placed physically at the distance from apparatus 100,
where first apparatus 100 contains:
At least one high-gain planar antenna for transmitting mm-wave radio signals 21, where the high-gain planar antenna has at least two radiation elements;
At least one high-gain planar antenna for receiving mm-wave radio signals 110, where the high-gain planar antenna has at least two radiation elements; where at least one high planar antenna, operating in 24 GHz to 300 GHz frequency band, 110 has a cross polarization compared to at least one transmit antenna 21
Integrated radio front end 10, implemented in arbitrary semiconductor technology, having on-chip integrated voltage control oscillator, power amplifier, at least one IQ demodulator, digital control interface, power supply;
Digital processing functionality 30 with arbitrary hard wired and SW digital processing capability, being able to digitally process the signal coming out of the entity 10, including controlling functionality and calculation and memory capacity for performing digital signal processing by arbitrary type of the realization options
Wired communication interface 60 to connect first Apparatus 100 to the vehicle infrastructure entity 1000, being outside the apparatus 100, being released by the plurality of the technologies and communication protocols
Supporting circuitry 50, including mechanical interface to vehicle environment 1000, where the first Apparatus 100 is connected to the infrastructure environment facing vehicle seat under observation, and supporting electronic circuitry for provide the power supply from the vehicle environment 1000 to the first apparatus 100.
where the second apparatus 2000:
is a passive, without power supply, and without capability of charging by the illumination of the mm-waves, being realized by plurality of realization options, having a key feature to reflect the incident waves coming from apparatus 100, in the same direction, with cross polarization, compared to the incident radio waves polarization, where radio waves are approaching the apparatus 2000.
Where at least one apparatus 2000 is integrated in the vehicle seat 299, facing in the direct view apparatus 100, being integrated inside vehicle cabin facing the seat 299

2: System according to claim 1, where
where apparatus 100 is connected to the fixed non-moving infrastructure with provided power supply
where at least one apparatus 2000 is positioned at fixed non-moving infrastructure 300 with fixed distance to the apparatus 100
where both apparatus 100 and 2000 are not inside of the vehicle.

3: System according to claim 1, where
where apparatus 100 is connected to the moving infrastructure 301 with provided power supply, where moving infrastructure 301 is vehicle
where at least one apparatus 2000 is positioned at fixed non-moving infrastructure 302

4: System according to claim 1, where
where at least one apparatus 100 is placed at the traffic infrastructure 503, with provided power supply
where at least one apparatus 2000 is placed at the traffic infrastructure 503, at the same height as corresponding apparatus 100, with fixed distance to the apparatus 100, across the road 504

5: System according to claim 1, where
where at least one apparatus 100 is placed in the industrial environment facing moving belt 304
where at least one apparatus 2000 is integrated in the moving belt 304

6: System according to claim 1, where
where at least one apparatus 100 is placed in the industrial environment facing rotating platform 506
where at least one apparatus 2000 is integrated in the rotating platform 506

7: System according to claim 1, where
where apparatus 100 is placed in the industrial environment facing apparatus 2000 at the same height positioned across the moving industrial belt 508, transporting packages 509, each containing 510 level of liquids inside of the package 509

8: Method of operation, utilizing the System being described in claim 1 where method of operation comprising three operation steps: “detecting seat occupancy” being declared as a first operation step, “detection of apparatuses 2000, by apparatus 100” being declared as second operation step, to be executed after the first step is executed, and “method for calculating human being classification”, being declared as third operation step to be executed after the second step is executed,
where the first operation step has following sub-set of operations:
Detecting by apparatus 100, if the human being is on the seat by using plurality of the approaches
where the second operation step has following sub-set of operations:
Transmission of mm-wave signals generated in 10 using 21;
Receiving radio signals reflected by apparatus 2000 area using at least one receiving antenna 110, having cross polarization compared to the antenna 21, operating in 24 GHz to 300 GHz frequency band;
Signal processing and detection at least three classes of the information:
Class one: no signal level detected above specific pre-defined threshold one
Class two: signal level detected above specific pre-defined threshold one, and lower than pre-defined threshold two, where the predefined threshold two is larger than predefined threshold one
Class three: signal level detected above specific pre-defined threshold three, where the predefined threshold two is larger than predefined threshold two
where third operation step being executed after the second operation step, has following sub-set of operations:
Mapping detected class of signal level to the event detection of the human being classification, according to the following rules:
If Class one is detected: average size human being is on the seat
If Class two is detected: smaller human being size, most probably a kid is on the seat
If Class three is detected: smaller life being is on the seat, most probably baby
Detected event is communicated to the vehicle environment 1000, by means of entity 60

9: Method of operation, utilizing the System being described in claim 2 where method of operation comprising three operation steps: “detecting visibility of apparatuses 2000, by apparatus 100” being declared as a first operation step, “observing cut in the visibility of apparatuses 2000, by apparatus 100” being declared as second operation step, to be executed after the first step is executed, and “method for calculating signal is broken”, being declared as third operation step to be executed after the second step is executed,
where the first operation step has following sub-set of operations:
Transmission of mm-wave signals generated in 10 using 21;
Receiving mm-wave signals reflected by apparatus 2000 area using at least one receiving antenna 110, having cross polarization compared to 21
Detecting by apparatus 100, if the apparatus 2000 is visible
where the second operation step has following sub-set of operations:
Transmission of mm-wave signals generated in 10 using 21;
Receiving mm-wave signals reflected by apparatus 2000 area using at least one receiving antenna 110;
Detecting by apparatus 100, if the apparatus 2000 is starting to be not visible, which is defined by using pre-defined threshold;
Memorising time of un-visibility detection
where third operation step being executed after the second operation step, has following sub-set of operations:
Detected event of un-visibility detection is reporting with time step of its calculation, by means of entity 60 to the world outside of apparatus 100

10: Method of operation, like in claim 9, related to the System described in claim 5, and claim 6 where the third operation step has additional sub-set of activities to calculate frequency of switching visibility and no-visibility, and sending this information over entity 60 to the world outside of apparatus 100.

11: Method of operation like described in the claim 9, related to the System described in claim 3, where the first operation step “detecting visibility of apparatuses 2000, by apparatus 100” is initialized by the moving platform 301, when the moving platform 301 is approaching the area, where the load 504 should be placed by the moving platform 301, and where the moving platform 301 will off-load 504, if the apparatus 2000 is visible, and will not off-load the load 504 if the apparatus 2000 is not visible.

12: Method of operation, utilizing the System being described in claim 7 where method of operation comprising three operation steps: “observing if the apparatus 2000 is visible, by apparatus 100” being declared as a first operation step, “observing if the visibility of apparatuses 2000, by apparatus 100 appears” being declared as second operation step, to be executed after the first step is executed, and “method for calculating liquid level in not sufficiently large”, being declared as third operation step to be executed after the second step is executed,
where the first operation step has following sub-set of operations:
Initialising Transmission of radio signals generated in 10 using 21; in the time slot when the package 509 is passing between apparatus 100 and apparatus 2000, operating in 24 GHz to 300 GHz frequency band
Receiving radio signals reflected by apparatus 2000 area using at least one receiving antenna 110, operating in 24 GHz to 300 GHz frequency band
Detecting by apparatus 100, if the apparatus 2000 is not visible
where the second operation step has following sub-set of operations:
Transmission of radio signals generated in 10 using 21, operating in 24 GHz to 300 GHz frequency band;
Receiving radio signals reflected by apparatus 2000 area using at least one receiving antenna 110, having cross polarization compared to 21, operating in 24 GHz to 300 GHz frequency band;
Detecting by apparatus 100, if the apparatus 2000 is starting to be visible, which is defined by using pre-defined threshold;
Memorising time of visibility detection
where third operation step being executed after the second operation step, has following sub-set of operations:
Event of insufficient liquid level inside package 509 is mapped to the event the visibility of apparatus 2000 is detected in the time slot, where the package is regularly passing between apparatus 100 and apparatus 2000, and after the event is reported together with time step of its calculation, by means of entity 60 to the world outside of apparatus 100, where pre-defined actions are further initialized by the world outside if apparatus 100.

13: Method of operation, utilizing the Method of operation like in claim 8-11, where machine learning process by the plurality of the applied algorithms are used to optimise the decision making pre-defined thresholds in the second operation step.
